(19) United States
(12) Patent Application Publication
(10) Pub. No.: US 2021/0232117 A1
(43) Pub. Date: Jul. 29, 2021

(54) RTU ADDON

(71) Applicant: Maarten Van Laere, Heverlee (BE)

(72) Inventor: Maarten Van Laere, Heverlee (BE)

(21) Appl. No.: 17/156,586

(22) Filed: Jan. 24, 2021

Related U.S. Application Data
(60) Provisional application No. 62/965,297, filed on Jan. 24, 2020.

(51) Int. Cl. G05B 19/406; G05B 19/408

(52) U.S. Cl. CPC G05B 19/406; G05B 2219/32179; G05B 2219/31457; G05B 19/408

(57) ABSTRACT

An ADDON for a networked sensor solution that provides a new innovative way for enabling the integration with legacy industrial control systems by connecting the ADDON in the same way as a sensor is connected to the base unit; wired or wireless; direct or indirect. The ADDON makes the data from the sensors directly available to ICS without having to connect to a network first, through industrial wired protocols such as but not limited to, Modbus RTU and BACnet MSTP.

### SEQUENCE LISTING OR PROGRAM

Not Applicable

### TECHNICAL FIELD OF THE PRESENT INVENTION

The present invention relates generally to a device that is directly connected into the sensor platform, typically like a regular sensor, to enable its integration with industrial controllers and industrial control systems (ICS) without the need of a network, ICS protocols converter or a base unit that has already ports or other connectivity available for ICS connection.

### BACKGROUND OF THE PRESENT INVENTION

Companies are deploying sensors to monitor their systems, equipment, processes and other tangible or non-tangible assets. The latest generation of sensors typically connect to a base unit. That base unit is then connected into an IP based network. This enables to integrate sensors with applications, systems & platforms.

A lot of installations still use systems & equipment relying on non-IP based industrial wired protocols such as, but not limited to, Modbus RTU (Remote Terminal Unit) or Bacnet and do not support modern IP based communication network protocols.

The objective is to enable legacy systems & equipment to get data from sensors.

To bridge legacy equipment and networked sensors, there are currently so-called industrial control protocols converter or gateway devices. These devices take data using IP based communication from networked sensors and make them available in industrial wired protocols such as, but not limited to, Modbus RTU or Bacnet.

The present invention creates a new way for networked sensors to share data with legacy systems & equipment.

### SUMMARY OF THE INVENTION

The invention is a physical device that expands the capabilities of the sensor platform by making the digital or analog data from sensors directly available to industrial controllers or industrial control systems over industrial wired protocols such as, but not limited to, Modbus RTU and BACnet.

For example, with the present invention a PLC could directly get the data from a sensor platform without the need of having it to be first connected onto the network using traditional ICS protocol converters.

Hereinafter the said invention is referred to as either “ADDON” or “RTU ADDON”. Hereinafter industrial controllers, industrial control systems, Supervisory Control and Data Acquisition (SCADA) systems, distributed control systems (DCS), or programmable logic controllers (PLCs) will all be referred to as “ICS”

The invention is called an addon as it expands the capabilities of a networked sensor platform. It can be fitted into the platform when the platform is installed for the first time or at a later phase.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a device enabling a new innovative way to integrate a networked sensor platform with ICS.

Another object is that the invention can be added into an existing or new sensor deployment and as such be an add-on or expansion for such a sensor deployment.

Another object is to provide a device that converts digital sensor data into legacy industrial protocols required by ICS such as, but not limited to, Modbus RTU and BACnet.

Another object is to provide a device that can be integrated into an existing sensor platform by using a physical or logical port that is available to connect a sensor. As such it behaves like a sensor so that it is backwards compatible with existing sensor deployments.

Another object is that with the present invention, a networked sensor platform can be directly integrated into one or more ICS systems without the need of a network for which the sensor platform was designed to connect to. This offers multiple benefits such as, but not limited to, being able to operate even with a network outage.

Another object is that ICS integration capability is in a device that is separate from the base unit of the sensor platform. This offers multiple benefits. For example, it enables to have the base unit in a physically separate space from the ICS and have the invention close to the ICS while still being connected to the base unit using a wired or wireless connection. A second benefit is that it allows for retrofitting existing sensor platforms to enable ICS integration.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

The accompanying drawings, which are incorporated herein and form a part of the specification, illustrate the present invention and, together with the description, further serve to explain the principles of the present invention and to enable a person skilled in the pertinent art to make and use the present invention.

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an infographic illustrating the overall operation of the present invention.

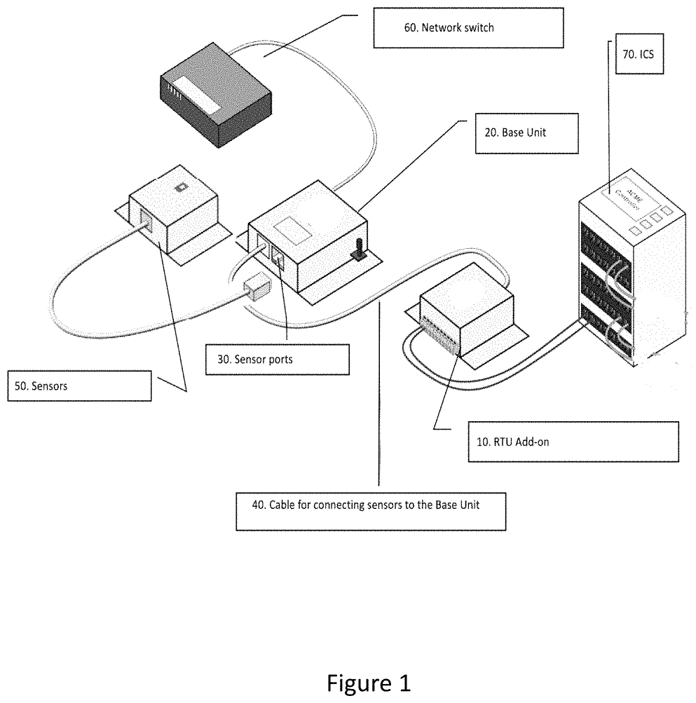

### DEFINITIONS

The said invention is referred to as either “ADDON” or “RTU ADDON”. The invention is called an addon as it expands the capabilities of a networked sensor platform. It can be fitted into the platform when the platform is installed for the first time or at a later phase.

Industrial controllers, industrial control systems, Supervisory Control and Data Acquisition (SCADA) systems, distributed control systems (DCS), or programmable logic controllers (PLCs) will all be referred to as “ICS”

Industrial Controller or Industrial Control System (ICS). ICS is a general term that encompasses several types of control systems and associated instrumentation used for industrial process control.

### INDEX OF ELEMENTS

10: RTU ADDON
20: Sensor Communication
30: Base Unit
40: Communication Protocols
50: Sensors
60: Network Switch
70: Industrial Controller

### DETAILED DESCRIPTION OF THE PRESENT INVENTION

In the following detailed description of the present invention of exemplary embodiments of the present invention, reference is made to the accompanying drawings (where like numbers represent like elements), which form a part hereof, and in which is shown by way of illustration specific exemplary embodiments in which the present invention may be practiced. These embodiments are described in sufficient detail to enable those skilled in the art to practice the present invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the present invention. However, it is understood that the present invention may be practiced without these specific details. In other instances, well-known structures and techniques known to one of ordinary skill in the art have not been shown in detail in order not to obscure the present invention. Referring to the FIGURES, it is possible to see the various major elements constituting the apparatus of the present invention.

### A. Overview

Turning now descriptively to the illustration, in which similar reference characters denote similar elements throughout the several views, the FIGURES illustrate one RTU ADDON that is connected in a wired way with the sensor platform's base unit. The ADDON makes the data from the sensor platform available to ICS and other systems using industrial wired protocols such as but not limited to, Modbus RTU and BACnet. While the RTU ADDON shows just one such RTU ADDON, multiple could be used in a same configuration. The illustration shows a wired connection of the RTU ADDON to the base unit. Such connection could also be wireless.

### B. RTU ADDON

The RTU ADDON connects like any regular sensor using a wired or wireless connection to the base unit. It can be connected direct or indirectly to the base unit. In the illustration we show a possible embodiment of a direct wired connection between the ADDON and the base unit.

Some base units today offer the functionality of integrating with ICS systems at a base unit level. With the present invention we enable to retro-fit existing sensor platforms by plugging an additional device into the sensor platform without the need of having a base unit with ICS integration capabilities.

The fact that the present invention connects to an existing wired or wireless sensor port makes it backwards compatible to existing sensor deployments.

The module is designed to have as a main purpose the creation of a bridge between IP based sensor platforms and legacy ICS. Without the invention, a user would typically require the use a module to convert from an IP protocol to an industrial serial (non-IP) protocol. With this present invention, a user can connect a sensor solution directly to an ICS without even requiring a network. This ensures that sensor data is available to the ICS regardless of the state of the network.

The RTU ADDON could be connected to an available sensor port on the base unit, an expansion hub of the base unit or any other type of physical connector such as, but not limited, RJ45, RJ11, M2, Coax connectors and other sensor connectors.

Another embodiment of the invention is a wireless connection of the RTU ADDON and the base unit or any other component as part of the sensor solution and before the networked IP connection.

### C. Sensor Communication

The communication between the sensor and the base unit can be digital or analog using a wired or wireless connection, or any combination thereof.

In the present invention, the RTU ADDON connects to a sensor platform's base unit using the same connectivity offered to sensors or expansion units; being it based on a wired or wireless connectivity.

Another embodiment of the invention is whereby the RTU ADDON connects to a non-sensor port of the platform's base unit or expansion unit.

Another embodiment of the invention is whereby the RTU ADDON connects using any type of wireless communication to the base unit or another device inside the sensor platform and before the networked IP connection.

The connection could send data in a bi-directional way between sensor and base unit. If it is a wired connection, then the base unit could also provide power to the ADDON.

### D. Base Unit

The base unit is the logical module to which sensors are connected either using a wired or wireless connection or a combination of both.

Typically, a base unit makes the values of digital or analog sensors available over an IP communication network for example (but not limited to) to other applications, modules, or to users. Other communication protocols could be used like for example satellite communications, LORA, SIGFOX or other protocols not present in the invention.

Some base units may offer embedded ICS integration into the base unit device itself; contrary to present invention whereby the ADDON is a separate device from the base unit.

### E. Applications

Networked sensor platforms are designed to integrate into applications and other systems.

Typical applications would be management platforms such as network management or building management platforms, that enable to centrally monitor, report and alert (or any combination thereof) sensors that are connected in the network and take actions based on the sensor data.

A non-limitative list of such applications: network monitoring systems, infrastructure monitoring software, DCIM, Scada, industrial automation, building management systems, IOT platforms, AI systems.

In this invention Applications may also refer to middleware. Middleware is a hardware or software solution that sits between the base unit (element 2) and the application (element 3). It could simply act as a pass-through, can perform operations (like but not limited to conversion, aggregation) on the data from the base unit.

### F. Communication Protocols

Networked sensor platforms communicate with systems & applications (as described above) over, but not limited to, an IP or non-IP based network.

Non exhaustive examples of such networked communication protocols are SNMP, Modbus TCP, Bacnet IP, Scada, HTTP, XML, REST API, JSON, MQTT.

Communication protocols in this invention refers to IP based network communication to integrate the base unit into a network or link the base unit with another system over a direct or indirect IP based network.

### G. Sensors

Sensors can be any type of analog or digital sensors or any combination thereof.

Sensors can serve a single purpose like, but not limited to, temperature measurement. It could also feature multiple different measurements in one same or multiple enclosure.

The sensor can be connected in a wired or wireless way with the base unit. It can even be included in the same enclosure as a base unit or part of the same electronics board as the base unit.

### H. Network Switch

Module to which a base unit connects to in order to be part of a wired IP network.

In the present invention, a network switch is an illustration of a possible embodiment. A sensor platform could connect in different ways to an IP network and not just through a switch; direct or indirect; wired or wirelessly.

The IP connectivity of the base unit is either wireless or wired; direct or indirect; or any combination thereof. The connection to the IP network can be direct such as, but not limited to, a network cable from the sensor platform's base unit into a router, network hub or switch. Such a connection could also be wireless. Connection to an IP network can also be indirect whereby the base unit first connects to a middleware which then connects it to an IP network. For example, a base unit could first connect to a satellite using satellite communications and from the ground station the data is then converted into IP network communications.

### I. Industrial Controller or Industrial Control System (ICS)

ICS is a general term that encompasses several types of control systems and associated instrumentation used for industrial process control.

Such systems can range from a few modular panel-mounted controllers to large interconnected and interactive distributed control systems with many thousands of field connections. All systems receive data received from remote sensors measuring process variables (PVs), compare these with desired set points (SPs) and derive command functions which are used to control a process through the final control elements (FCEs), such as control valves.

The larger systems are usually implemented by Supervisory Control and Data Acquisition (SCADA) systems, or distributed control systems (DCS), and programmable logic controllers (PLCs), though SCADA and PLC systems are scalable down to small systems with few control loops. Such systems are extensively used in industries such as chemical processing, pulp and paper manufacture, power generation, oil and gas processing and telecommunications.

### J. Connections of Main Elements and Sub-Elements of Invention

A typical implementation of this invention in a wired sensor platform would be a device that includes the features as described in the illustration. This device would plug into an available sensor port of the base unit or expansion unit using a cable which provides power and data transfer between the invention and the base or expansion unit.

The base unit connects to an IP network and makes the data available over one or more network protocols to applications & systems.

### K. Alternative Embodiments of Invention

A variation of above typical configuration and connectivity between the elements is whereby the ADDON does not connect to a port reserved for sensors but to a port reserved for addons in general or ICS communication in particular.

The ADDON is referred to as RTU ADDON in this document; this invention does not only cover Bacnet MSTP, Modbus RTU but any other non-IP based industrial protocol.

### L. Operation of Preferred Embodiment

Typically, customers would need to install an industrial converter device that converts the networked protocols supported by the base unit into industrial protocols for the ICS such as, but not limited, Modbus RTU and Bacnet MSTP.

Above has a lot of disadvantages compared to this invention.

The invention is designed to leverage an existing connectivity to a base unit that is typically reserved for connecting sensors only. With this invention no hardware changes are needed onto base units to support integration into ICS.

By not embedding the connection for industrial communication required for the ICS into the base unit, ADDONs can be placed separately, even in different locations, compared to the base unit for improved connectivity. The connection between the ADDON and base unit can be wired or wireless.

What has been described and illustrated herein is a preferred embodiment of the invention along with some of its variations. The terms, descriptions and FIGURES used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

What has been described and illustrated herein is a preferred embodiment of the present invention along with some of its variations. The terms, descriptions and FIGURES used herein are set forth by way of illustration only and are not meant as limitations. Those skilled in the art will recognize that many variations are possible within the spirit and scope of the present invention in which all terms are meant in their broadest, reasonable sense unless otherwise indicated. Any headings utilized within the description are for convenience only and have no legal or limiting effect.

Thus, it is appreciated that the optimum dimensional relationships for the parts of the present invention, to include variation in size, materials, shape, form, function, and manner of operation, assembly, and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the present invention should be determined by the appended claims and their legal equivalents, rather than by the examples given.

The embodiments of the present invention in which an exclusive property or privilege is claimed are defined as follows:

1. A RTU (Remote Terminal Unit) add on device that can be connected into a networked sensor platform to enable its integration with industrial controllers and industrial control systems (ICS) without the need of a network, the device comprising:
one RTU add on device connected with a sensor platform's base unit;
the base unit is the logical module to which sensors are connected;
the base unit makes the values of digital or analog sensors available over an IP communication network to other applications, modules, or users;
the RTU add on device connects, like a sensor, to the base unit;
creation of a bridge between IP based sensor platforms and legacy ICS;
communication between the sensor and the base unit can be digital or analog using a wired or wireless connection, or any combination thereof; and
the add on device making the data from the sensor platform available to an ICS and other systems using industrial wired protocols.

2. The RTU add on device of claim 1, wherein the RTU add on device shows just one such RTU add on device, multiple could be used in a same configuration.

3. The RTU add on device of claim 1, wherein the RTU add on device has a wired or wireless connection to the base unit.

4. The RTU add on device of claim 1, wherein the RTU add on device connected direct or indirectly to the base unit.

5. The RTU add on device of claim 3, wherein connecting to an existing wired or wireless sensor port makes the RTU add on device backwards compatible to existing sensor deployments.

6. The RTU add on device of claim 1, enabling
connecting a sensor solution directly to an ICS without requiring a network; and
ensuring that sensor data is available to the ICS regardless of the state of the network.

7. The RTU add on device of claim 1,
connected to an available sensor port on the base unit, an expansion hub of the base unit, or a physical connector.

8. The RTU add on device of claim 3, wherein
the wireless connection of the RTU add on device and the base unit or any other component is part of the sensor solution and before the networked IP connection.

9. The RTU add on device of claim 1, wherein
the RTU add on device connects to a sensor platform's base unit using the same connectivity offered to sensors or expansion units; being it based on a wired or wireless connectivity.

10. The RTU add on device of claim 1, wherein
the RTU add on device connects to a non-sensor port of the platform's base unit or expansion unit.

11. The RTU add on device of claim 1, wherein
the RTU add on device connects using any type of wireless communication to the base unit or another device inside the sensor platform and before the networked IP connection.

12. The RTU add on device of claim 1, wherein
the connection sends data in a bi-directional way between sensor and base unit; and
if it is a wired connection, then the base unit also provides power to the RTU add on device.

13. The RTU add on device of claim 1, wherein
sensors can be any type of analog or digital sensors or any combination thereof;
sensors can be connected in a wired or wireless way with the base unit; and
sensors can serve a single purpose or feature multiple different measurements in one same or multiple enclosure.

14. The RTU add on device of claim 1, wherein
the IP connectivity of the base unit is either wireless or wired; direct or indirect; or any combination thereof.

15. The RTU add on device of claim 1, wherein
the RTU add on device plugs into an available sensor port of the base unit or expansion unit using a cable which provides power and data transfer between the invention and the base or expansion unit; and
the base unit connects to an IP network and makes the data available over one or more network protocols to applications & systems.

15. The RTU add on device of claim 1, wherein
the RTU addon device connects to a port reserved for addons in general or ICS communication in particular.
